(19) United States
(12) Patent Application Publication
(10) Pub. No.: US 2013/0014504 A1
(43) Pub. Date: Jan. 17, 2013

(54) DEVICE FOR CONVERTING WASTE HEAT OF AN INTERNAL COMBUSTION MACHINE INTO MECHANICAL ENERGY

(71) Applicants: Achim Brenk, Kaempfelbach (DE); Dieter Seher, Ilsfeld (DE)

(72) Inventors: Achim Brenk, Kaempfelbach (DE); Dieter Seher, Ilsfeld (DE)

(73) Assignee: ROBERT BOSCH GMBH, Stuttgart (DE)

(21) Appl. No.: 13/522,060

(22) PCT Filed: Dec. 6, 2010
(86) PCT No.: PCT/EP2010/068917

§ 371 Date: Oct. 1, 2012

(30) Foreign Application Priority Data
Jan. 13, 2010 (DE) 102010000854.0

(51) Int. Cl. F02G 3/02

(52) U.S. Cl. 60/614

(57) ABSTRACT

The invention relates to a device (1) for converting waste heat of an internal combustion machine (2) into mechanical energy. The device comprises a piston machine (3) that converts the waste heat of the internal combustion machine (2) during an OCR process into mechanical energy which can be transmitted onto a shaft (7) driven by the internal combustion machine (2). Furthermore, a variable gear (6) is provided via which the piston machine (3) transmits the mechanical energy onto the shaft (7) of the internal combustion machine (2). The variable gear (6) translates an initial rotational speed of the piston machine (3) into a rotational speed of the shaft (7) driven by the internal combustion machine (2). In this way, the ORC process can be carried out in an optimal manner.

### BACKGROUND OF THE INVENTION

The invention relates to a device for converting waste heat of an internal combustion machine into mechanical energy. The invention particularly relates to a device for converting waste heat of an internal combustion machine of a motor vehicle into additional mechanical driving power.

Systems for the utilization of waste heat are also conceivable for stationary engines or large engines. The use of such systems for mobile applications is however problematic. In the case of mobile applications, the problem is namely that the instantaneous supply of waste heat is dependent on the driving condition. The driving condition is, for example, determined by a traffic situation, the load of the vehicle, an ascent and the driving speed. The supply of waste heat is therefore subject to significant changes.

### SUMMARY OF THE INVENTION

The device according to the invention has in contrast the advantage that the waste heat of an internal combustion machine can be converted into mechanical energy, wherein an adaptation to the currently available waste heat of the internal combustion machine is advantageously possible. A continuous adjustment of a volume flow of the piston machine is particularly possible, and in so doing an adaptation to the heat flow of the internal combustion machine is also possible without thereby varying the parameters of the thermodynamic process.

The device for converting waste heat of an internal combustion machine can particularly be used in mobile equipment, in particular in motor vehicles. In this case, the thermal energy of the waste heat is converted via the ORC (Organic Rankine Cycle) process into mechanical energy. In so doing, the waste heat from the exhaust gas of the internal combustion machine or from an exhaust gas recirculation can be advantageously transferred via a heat exchanger to a working fluid of the ORC process. The working fluid can thereby be vaporized. This vapor can subsequently be expanded in the piston machine which is operating as an expansion machine, wherein mechanical energy is obtained and is delivered to the shaft of the internal combustion machine via the variable gear. Variations in the supply of waste heat can thereby be compensated by means of the variable gear. The cutoff of one or a plurality of cylinders of the piston machine is therefore not required. The cutoff of individual cylinders of the piston machine has namely the disadvantage that this can take place only in discrete steps. In addition, a cutoff in pairs of piston elements, which are opposite to one another, is normally required in a piston machine configured as an axial piston engine or a radial piston machine in order to prevent asymmetrical rotational movements. A continuous adjustment of the volume flow of the piston machine can therefore not take place as a result of a cylinder cutoff. This would further require an additional adaptation of the parameters of the ORC process to the delivery volume. A continuous adjustment of the volume flow of the piston machine is however possible by means of the use of the variable gear; and therefore an adaptation to the heat flow of the internal combustion machine is possible without having to vary the parameters of the ORC process at the same time.

The use of the variable gear thus facilitates a continuous adaptation of the volume flow of the piston machine to the volume flow of the ORC process when the ORC process is adapted to the waste heat supply of the internal combustion machine. A cutoff of individual piston elements or inlet channels is not required in the process. The adaptation takes place via a steplessly adjustable gear ratio of the piston machine to the shaft driven by the internal combustion machine.

An optimal efficiency of the piston machine can be achieved in this way independently of the operating parameters of the internal combustion machine, in particularly independently of the heat dissipation and the rotational speed. In this case, the piston machine can advantageously convert the waste heat of the internal combustion machine into mechanical energy at a design point determined by an expansion ratio. The piston machine can therefore always be operated at the design point thereof. Depending on the gear configuration used, a closed-loop or open-loop control of the gear ratio of the gear is not necessary because the gear can adapt itself in a self-regulating manner to the two impressed rotational speeds. It is therefore further advantageous for the variable gear to be designed as a self-regulating variable gear, wherein the gear adapts itself on the one hand to the initial speed of the piston machine and on the other hand to the rotational speed of the shaft driven by the internal combustion machine. A toroidal gear, in particular a full toroidal gear, or a NuVinci gear can be advantageously used as the variable gear.

If the pressure levels of the ORC process, namely the evaporation pressure and the condensation pressure, are adjusted to the expansion ratio of the piston machine, the rotational speed of the piston machine follows the generated vapor flow, i.e. the volume flow of the ORC process. The rotational speed of the piston machine is preferably equal to the initial rotational speed of said piston machine and consequently to the input rotational speed for the variable gear. The output rotational speed of the variable gear is determined by the instantaneous rotational speed of the shaft driven by the internal combustion machine, in particular of a crankshaft of said internal combustion machine. In this case, the output rotational speed of the gear can be equal to the rotational speed of the crankshaft. Due to these two predefined boundary conditions at the input as well as the output side of the variable gear, the running wheels of a toroidal gear are forced into a defined position; and therefore a control of the gear ratio is not required in this case. The same is true when using a NuVinci gear.

A working fluid of the ORC process can advantageously consist at least substantially of water. Other working fluids can however be used.

The working fluid of the ORC process is compressed by a pump in the liquid phase to a pressure level for evaporation. The heat energy of the exhaust gas as well as that of the exhaust gas recirculation is subsequently transmitted to the working fluid of the ORC process via a heat exchanger. In so doing, the working fluid is isobarically evaporated and subsequently superheated. The vapor in the piston machine is then adiabatically expanded. Mechanical energy is thereby obtained and transferred to the shaft of the internal combustion machine via the variable gear. The working fluid is now cooled in a condenser and delivered again to the pump. In this way, the circuit is closed.

Depending on the operating point of the internal combustion machine, the exhaust gas mass flow, the mass flow of the exhaust gas recirculation and the temperatures of the exhaust gas and exhaust gas recirculation vary. The volume flow of the working fluid must thereby be adapted to the heat supply of the internal combustion machine because on the one hand as large a proportion as possible of thermal energy is to be converted into mechanical energy and on the other hand the exhaust gas recirculation is to be cooled down as greatly as possible. Changes in the volume flow also require an adaptation of the piston machine, i.e. either the stroke volume is varied, which can occur by the cutoff of individual piston elements and is thereby undesirable or the rotational speed of the piston machine is changed.

If the piston machine were connected to the shaft of the internal combustion machine via a solid gearing, the volume flow could only be achieved by cutting off individual piston elements of the piston machine or by a variation in the process pressure. By deactivating individual piston elements, the volume flow can however only be changed in discrete steps. If there are still deviations present between the volume flow required for the heat absorption and the volume flow implemented by the piston machine after the cutoff of individual cylinders, this must then be compensated for via an adaptation of the evaporation temperature and the superheating temperature. An adaptation of the evaporation temperature of the ORC process leads to the compression ratio and the volume ratios of the ORC process no longer matching with the expansion ratio. This results in a decrease in the efficiency.

If, for example, the super heating temperature is raised, it is then unavoidable that a large quantity of vapor enters the condenser, which entails additional technical requirements because said condenser now assumes a larger construction volume and must deal with an unfavorable heat transfer during the vaporous phase of the working fluid. At the same time, the efficiency of the piston machine also decreases because the friction loss remains constant due to the predefined rotational speed; however, the implemented work is reduced due to the element cutoff.

An adaptation of the volume flow of the piston machine is thus facilitated in an advantageous manner by changing the gear ratio of the variable gear. The work delivered by the piston machine is transmitted to the shaft of the internal combustion machine via the gear ratio. The use of the variable gear facilitates in this case a stepless adaptation of the volume flow of the piston machine without cutting off individual piston elements or raising the superheating temperature of the ORC process.

The waste heat can therefore be used by means of the device for converting the waste heat of the internal combustion machine into mechanical energy. In so doing, the conversion of said waste heat into mechanical energy results and a feedback to the shaft of the internal combustion machine, in particular to a crankshaft, takes place.

It is advantageous for the device to be designed in such a way that the waste heat of the internal combustion machine is absorbed from a cooling circuit of said internal combustion machine. In this case, the waste heat can be extracted from the coolant of the cooling circuit.

### BRIEF DESCRIPTION OF THE DRAWINGS

Preferred exemplary embodiments of the invention are explained in detail in the following description with reference to the accompanying drawings. In the drawings:

FIG. 1 shows an exemplary embodiment of a device for converting waste heat of an internal combustion machine into mechanical energy in a schematic depiction and

FIG. 2 shows a diagram for explaining the operation of the device of the exemplary embodiment of the invention.

### DETAILED DESCRIPTION

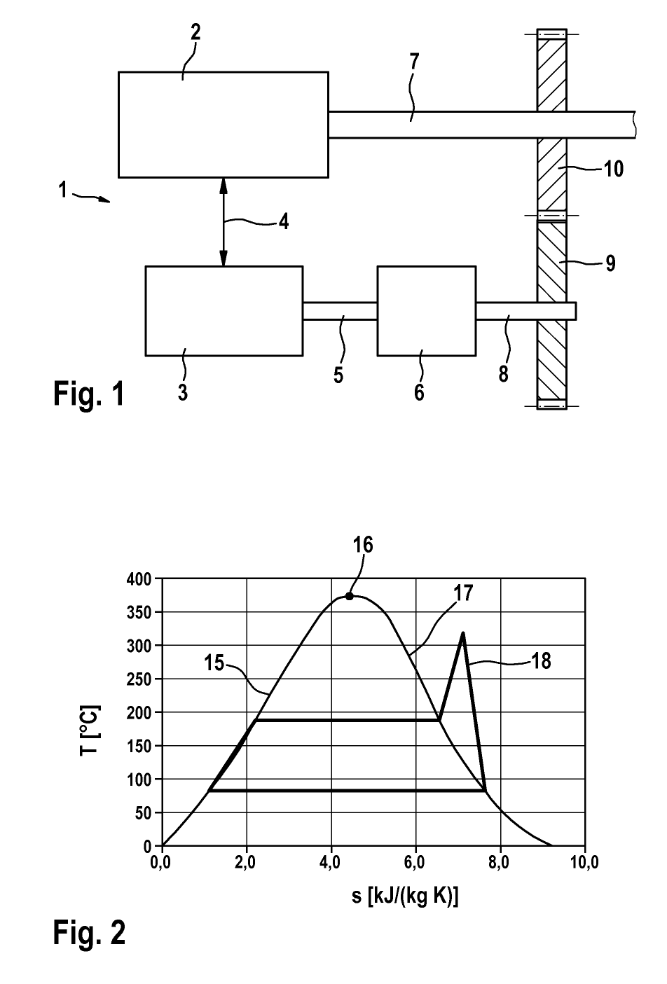

In a schematic depiction, FIG. 1 shows an exemplary embodiment of a device 1 for converting waste heat of an internal combustion machine 2 into mechanical energy. The device 1 is used in mobile applications. Said device 1 can especially be employed in commercial vehicles or passenger cars. Said device 1 according to the invention is however suitable for other applications.

The device 1 comprises a piston machine 3, which is connected to the internal combustion machine 2 via a heat exchanger 4 as is illustrated by the double-headed arrow 4. In so doing, the exhaust gases of the internal combustion machine 2 can, for example, be transferred as waste heat of the internal combustion machine 2 to the piston machine 3. Said piston machine 3 converts the waste heat into mechanical energy, wherein a shaft 5 is driven. In this case, the piston machine 3 drives the shaft 5 with the initial rotational speed of said piston machine 3. Said piston machine 3 is connected via the shaft 5 to a gear 6. The gear 6 is designed as a variable gear. The internal combustion machine 2 drives a shaft 7, which is configured as a crankshaft 7 in this exemplary embodiment. The variable gear adapts an output rotational speed of an output shaft 8 of the gear 6 as a function of the instantaneous rotational speed of the drive shaft 7. The output shaft 8 is in operative connection with the crankshaft 7. Said operative connection is illustrated by gear wheels 9, 10 which engage one another.

A direct coupling of the gear 6 with the crankshaft 7 is also possible.

Waste heat generated by the internal combustion machine 2 can therefore at least partially be converted into mechanical energy, which is transmitted onto the crankshaft 7 as additional driving power. The efficiency can thereby be improved.

The variable gear 6 is designed as a self-regulating variable gear 6. As a result, the gear 6 adapts on the one hand to the initial rotational speed of the piston machine 3, i.e the rotational speed of the shaft 5, and on the other hand to the rotational speed of the crankshaft 7, which is driven by the internal combustion machine 2. In this case, the variable gear 6 can be designed as a toroidal gear, in particular a full toroidal gear. Said variable gear 6 can also be designed as a NuVinci gear 6.

FIG. 2 shows a diagram which illustrates the operation of the device 1 for converting waste heat of the internal combustion machine 2 into mechanical energy. In this case of a working fluid of the piston machine 3, the entropy s is plotted on the abscissa, while the temperature T is plotted on the ordinate. Water is selected by way of example as the working fluid in this instance. A liquid curve 15 is depicted in the diagram, which rises up until a critical point 16 of water. Furthermore, a saturated vapor curve 17 is depicted starting at the critical point 16. The water used as an example for the working fluid has in this case a falling saturated vapor curve 17 as is shown in the diagram. Other curve profiles can result with other working fluids. In particular, the saturated vapor curve can also rise.

In addition, the thermodynamic ORC process is illustrated as a closed curve 18.

The Organic Rankine cycle process, i.e ORC process is selected as the thermodynamic process. The water serving as the working fluid is compressed by a pump in the liquid phase to the pressure level for evaporation. The heat energy of the exhaust gas is subsequently transmitted to the working fluid water via the heat exchanger 4. In so doing, the working fluid is isobarically evaporated and subsequently superheated. The vapor in the piston machine is then adiabatically expanded. Mechanical energy is thereby obtained and transmitted to the crankshaft 7 via the gear 6. The water serving as the working fluid is now cooled in a condenser and delivered again to the pump.

The device 1 can be designed in such a way that the waste heat of the internal combustion machine 2 is absorbed from a cooling circuit of said internal combustion machine 2. In this case, the waste heat can be extracted from the coolant of the cooling circuit.

The invention is not limited to the exemplary embodiments which are described.

1. A device (1) for converting waste heat of an internal combustion machine (2) into mechanical energy, said device comprising a piston machine (3) that converts the waste heat of the internal combustion machine (2) during an ORC process into mechanical energy, which can be transmitted onto a shaft (7) driven by said internal combustion machine (2), and a variable gear (6) via which the piston machine (3) transmits the mechanical energy onto the shaft (7) of said internal combustion machine (2), wherein the variable gear (6) translates an initial rotational speed of said piston machine (3) into a rotational speed of the shaft (7) driven by said internal combustion machine (2).

2. The device according to claim 1, characterized in that the piston machine (3) converts the waste heat of the internal combustion machine (2) into mechanical energy at least approximately at a design point determined by an expansion ratio.

3. The device according to claim 2, characterized in that the initial rotational speed of the piston machine (3) at the design point follows a generated vapor flow of the ORC process.

4. The device according to claim 1, characterized in that the variable gear (6) is designed as a self-regulating and or torque sensitive variable gear (6), wherein said gear (6) on the one hand adapts to the initial rotational speed of the piston machine (3) and on the other hand to the rotational speed of the shaft (7) driven by the internal combustion machine (2).

5. The device according to claim 4, characterized in that the variable gear (6) is a toroidal gear.

6. The device according to claim 1, characterized in that a working fluid of the ORC process consists at least substantially of water.

7. The device according to claim 1, characterized in that the ORC process is designed in such a way that during an ORC process, a working fluid of said ORC process is compressed in a liquid phase to a pressure level for evaporation, the waste heat of the internal combustion machine (2) being subsequently transmitted to the working fluid, wherein an isobaric evaporation and superheating of the working fluid results, the vaporous working fluid being subsequently expanded to generate the mechanical energy and the working fluid being thereafter cooled and transferred again into the liquid phase.

8. The device according to claim 1, characterized in that the mechanical energy generated via the ORC process serves as additional driving power, which is transmitted onto the shaft (5) driven by the internal combustion machine (2).

9. The device according to claim 1, characterized in that the ORC process extracts the waste heat of the internal combustion machine (2) at least partially from one of the exhaust gas of said internal combustion machine (2) and an exhaust gas recirculation associated with said internal combustion machine (2) and converts said waste heat into mechanical energy.

10. The device according to claim 1, characterized in that the waste heat of the internal combustion machine (2) is absorbed from a cooling circuit of said internal combustion machine (2).

11. The device according to claim 1, characterized in that the variable gear (6) is a full toroidal gear.

12. The device according to claim 1, characterized in that the variable gear (6) is a NuVinci gear 6.

13. The device according to claim 3, characterized in that the variable gear (6) is designed as a self-regulating and or torque sensitive variable gear (6), wherein said gear (6) on the one hand adapts to the initial rotational speed of the piston machine (3) and on the other hand to the rotational speed of the shaft (7) driven by the internal combustion machine (2).

14. The device according to claim 13, characterized in that the variable gear (6) is a toroidal gear.

15. The device according to claim 13, characterized in that the variable gear (6) is a full toroidal gear.

16. The device according to claim 13, characterized in that the variable gear (6) is a NuVinci gear 6.

17. The device according to claim 14, characterized in that a working fluid of the ORC process consists at least substantially of water.

18. The device according to claim 17, characterized in that the ORC process is designed in such a way that during an ORC process, a working fluid of said ORC process is compressed in a liquid phase to a pressure level for evaporation, the waste heat of the internal combustion machine (2) being subsequently transmitted to the working fluid, wherein an isobaric evaporation and superheating of the working fluid results, the vaporous working fluid being subsequently expanded to generate the mechanical energy and the working fluid being thereafter cooled and transferred again into the liquid phase.

19. The device according to claim 18, characterized in that the mechanical energy generated via the ORC process serves as additional driving power, which is transmitted onto the shaft (5) driven by the internal combustion machine (2).

20. The device according to claim 19, characterized in that the ORC process extracts the waste heat of the internal combustion machine (2) at least partially from one of the exhaust gas of said internal combustion machine (2) and an exhaust gas recirculation associated with said internal combustion machine (2) and converts said waste heat into mechanical energy.

21. The device according to claim 20, characterized in that the waste heat of the internal combustion machine (2) is absorbed from a cooling circuit of said internal combustion machine (2).
